(19) United States
(12) Patent Application Publication
(10) Pub. No.: US 2007/0182939 A1
(43) Pub. Date: Aug. 9, 2007

(54) DIGITAL PROJECTION SYSTEM WITHOUT A COLOR FILTER

(75) Inventors: Andrew Huibers, Palo Alto, CA (US); Regis Grasser, Mountain View, CA (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/671,845

(22) Filed: Feb. 6, 2007

Related U.S. Application Data
(60) Provisional application No. 60/771,133, filed on Feb. 6, 2006.

(51) Int. Cl. G03B 21/14

(52) U.S. Cl. 353/84; 348/743; 348/771

(57) ABSTRACT

A digital system without a color filter is provided. The desired color components are produced by a light source capable of emitting the desired color components. The color components are delivered to the pixels of the spatial light modulator through a group of optical lens and/or lightpipes, but without a color filter.

### CROSS REFERENCE TO RELATED APPLICATIONS

This US patent application claims priority under 35 U.S.C. 119(e) from co-pending U.S. provisional application Ser. No. 60/771,133 to Huibers filed Feb. 6, 2006, the subject matter being incorporated herein by reference in its entirety.

### TECHNICAL FIELD

The technical field of the examples to be disclosed in the following sections is related generally to the art of projection systems, and more particularly, to digital projection systems without a color filter.

### BACKGROUND

Current digital display systems such as micromirror-based projection TVs and projectors use color filters to produce color components from white light for the display systems. Specifically, the color filter, such as a spinning color wheel comprises color segments corresponding to the desired color components. By spinning the color wheel, the desired color components are sequentially derived from white light that illuminates the color wheel. The derived color components are then directed to the pixels of the spatial light modulator of the display system.

Proper operation of the color filter require auxiliary facilities, such as a motor for spinning the color wheel, and often times a photodetector to detect the phase of the color segments. It is obvious that the color filter and auxiliary facilities occupy certain space in the display system, which, except in some rare cases where a large facility like a movie theater, is often desired to be compact or slim. Moreover, the color wheel and auxiliary facilities increase the weight of the display system, which may be noticeable in portable projection systems.

The operation of the color wheel and its facilities also complicate the system design. In addition to simply spinning the color wheel, the operation of the color wheel is often desired to be synchronized with other operations of the system, such as the source signals. Such synchronization is expected to satisfy particular requirements. For example, the synchronization is expected to be capable of handling source signals of abnormal behaviors, such as missing of the source signals, source signals of improper frequencies, and source signals containing abrupt phase discontinuities. Phase discontinuity may occur when for example, a user changes channel in watching a TV/HDTV when the video source is TV/HDTV, or when the noise is significant, or signal jittery when the signal strength of the signal source transmitter is far away from the receiver such that the noise is significant as compared to the strength of the video signals. The synchronization is also expected to be flexible and programmable to be easily adapted to different operational environments. The synchronization is further expected to be capable of handling synchronizations between multiple signals to the source signals, where the multiple signals may vary in frequencies and/or phases over the source signals. Satisfaction of these requirements needs additional control modules.

The color wheel also carries intrinsic deficiencies, such as in color and/or optical efficiency. Correction and compensation of these deficiencies also require additional efforts and modules. For example, when different light sources are used, modulation methods, such as the pulse-width-modulation algorithms will need to be modified, which certainly degrades compatibility of the color wheels to light sources.

### SUMMARY

As an example, a digital system without a color filter (e.g. without a rotatable color wheel) is provided. The desired color components are produced by a light source capable of emitting the desired color components. The color components are delivered to the pixels of the spatial light modulator through a group of optical lens and/or lightpipes.

### BRIEF DESCRIPTION OF DRAWINGS

FIG. 1 diagrammatically illustrates an exemplary display system in which embodiments of the invention can be implemented;

FIG. 2 diagrammatically illustrates another exemplary display system in which embodiments of the invention can be implemented;

FIG. 3 diagrammatically illustrates yet another exemplary display system in which embodiments of the invention can be implemented;

FIG. 4 demonstratively illustrates an array of LEDs used as the light source in the projection system in FIG. 3;

FIG. 5 demonstratively illustrates another example of using an array of LEDs as the light source for illuminating multiple spatial light modulators employed concurrently in a display system;

FIG. 6 demonstratively illustrates a display system wherein multiple LEDs of different colors and multiple spatial light modulators are employed;

FIG. 7 demonstratively illustrates a cross-sectional view of an exemplary spatial light modulator having array of deflectable reflective mirror plates;

FIG. 8 demonstratively illustrates a cross-sectional view of another exemplary spatial light modulator having array of deflectable reflective mirror plates;

FIG. 9 demonstratively illustrates a cross-sectional view of an exemplary micromirror device that can be used in the spatial light modulators shown in FIGS. 7 and 8;

FIG. 10 demonstratively illustrates a perspective view of an exemplary micromirror device having the cross-sectional view of FIG. 9;

FIG. 11 demonstratively illustrates a perspective view of another exemplary micromirror device having the cross-sectional view of FIG. 9;

FIG. 12 demonstratively illustrated a perspective view of a spatial light modulator having an array of micromirror devices in FIG. 11;

FIG. 13 is a top view of another exemplary spatial light modulator useable in the projection system of the invention;

FIG. 14 is a top view of yet another exemplary spatial light modulator useable in the projection system of the invention;

FIG. 15 is a top view of yet another exemplary spatial light modulator useable in the projection system of the invention;

FIGS. 16a, 16b, and 16c are top views of yet another exemplary spatial light modulator useable in the projection system of the invention; and

FIG. 17 demonstratively illustrates a top view of yet another exemplary micromirror array usable in the projection system of the invention.

### DETAILED DESCRIPTION OF THE EMBODIMENTS

Disclosed herein is a projection system capable of producing color images without a color filter. Color components of the illumination light are produced by an illumination system in the absence of a color filter, and directed to the pixels of the spatial light modulator sequentially or concurrently. The spatial light modulator modules the color components according a stream of image data so as to produce the desired color image.

In the following, selected display system examples will be discussed, wherein the pixels of the spatial light modulator in the systems are micromirror devices. However, it will be appreciated that the following discussion is for demonstration purposes, and should not be interpreted as a limitation. Instead, other variations are also applicable. For example, the present invention is also applicable to other type of projection systems, such as Liquid-crystal, display, liquid-crystal-on-silicon, plasma, CCD, and other projection systems. Depending upon the optical arrangement, the projection system can be rear-projection systems and front-projection systems.

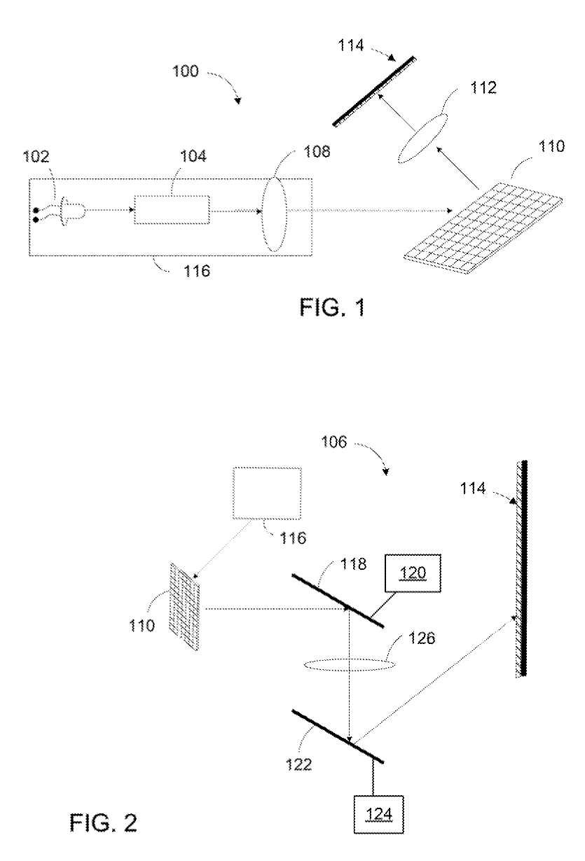

Turning to the drawings, FIG. 1 illustrates an exemplary projection system. Projection system 100 comprises illumination system 116, spatial light modulator 110, projection lens 112, and screen 114. The illumination system further comprises light source 102, lightpipe 104, and lens group 108. Unlike those in the related art, the projection system does not have a color filter for producing color components, but is still capable of producing color images.

For producing color images, color light beams, such as red, green, blue, or cyan, yellow, magenta, or other color beams, are required to illuminate the spatial light modulator. For this purpose, the illumination system comprises an array of light sources each being capable of producing one of the desired color light beams. An exemplary type of such light sources is light-emitting-diodes (LEDs). LEDs used as light sources in a projection system is superior over traditional arc lamps in many aspects, such as low cost, compact size, longer lifetime, lower heating, and narrower bandwidth than arc lamps. As an example, gallium nitride light emitting diodes can be used for the green and blue arrays, and gallium arsenide (aluminum gallium arsenide) could be used for the red light emitting diode array. LEDs such as available or disclosed by Nichia™ or Lumileds™ could be used, or any other suitable light emitting diodes. Some of the current LEDs have a lifetime of 100,000 hours or more, which is almost 10 times higher than the lifetime of the current UHP arc lamp with the longest lifetime. LEDs are cold light source, which yields much less heat than arc lamps. Even using multiple LEDs in a display system, the total heat generated by the LEDs can be dissipated much easier than using the arc lamps, because the heat generated by the LEDs is omni-directional as compared to the heat generated by the arc lamps wherein the heat has preferred orientations. Currently, LEDs of different colors have been developed. When multiple LEDs of different colors, such as red, green, and blue, are concurrently employed in the display system, beam splitting elements, such as color wheel, that are required for the arc lamp, can be omitted. Without light splitting elements, system design and manufacturing can be significantly simplified. Moreover, the display system can be made more compact and portable.

As compared to current arc lamps, LEDs are also superior in spectrum. The spectrum of a LED has a typical width of 10 nm to 35 nm. However, the typical spectrum width of the colors (e.g. red, green, and blue) derived from the color wheel used in combination with an arc lamp is approximately 70 nm, which is much larger than that of the LED. In other words, LEDs have much purer colors than arc lamps, resulting in more abundant colors than arc lamps.

Like arc lamps, LEDs may have the color balance problem, wherein different colors may have different intensities. This problem for LEDs, however, can be solved simply by time-mixing or spatial-mixing mode. In spatial-mixing mode, different number of LEDs for different colors can be provided for balancing the intensity discrepancies in different colors. In time-mixing mode, the color can be balanced by tuning the ON-time ratio of different LEDs for different colors, which will be detailed afterwards with reference to FIG. 5. To be commensurate with the display system, the LEDs used in the projection system preferably have a light flux of 3 lumens or higher, such as 4.4 lumens or higher, and 11.5 lumens or higher.

Using multiple LEDs of different colors has other practical benefits as compared to using the arc lamp and color wheel. In the display system using the arc lamp and color wheel, color transition unavoidably occurs as the color wheel spins and color fields in the color wheel sequentially sweeps across the micromirror array of the spatial light modulator. The color transition cast extra design for the system, which complicate the system. Moreover, color transition reduces optical efficiency of the system, for example, a portion of the incident light has to be sacrificed. As a comparison, LEDs may not have the color transition problem. Regardless whether the LEDs sequentially or concurrently illuminating the micromirror devices of the spatial light modulator, all micromirror devices of the spatial light modulator can be illuminated by a light beam of specific color at a time.

In practical operation, it may be desired that different colors have approximately the same or specific characteristic spectrum widths. It may also be desired that different colors have the same illumination intensity. These requirements can be satisfied by juxtaposing certain number of LEDs with slightly different spectrums, which will detailed afterwards in FIG. 5.

Because the light source (102) is capable of providing desired color light beams, a color filter, such as a color wheel in current display systems) is not required in the system for producing color images. The produced color light beams from the light source are delivered to the pixels of spatial light modulator 110, and modulated thereby. Delivery of the color light beams from the light source to the spatial light modulator may be accomplished through a lightpipe (104) and lens group 108, but may not be required.

The lightpipe (104) can be a standard lightpipe that are widely used in digital display systems for delivering homogenized light from the light source to spatial light modulators. For example, the lightpipe may be a light tunnel formed by multiple reflective surfaces bonded together with an entrance and exit. Alternatively, the lightpipe can be the one with movable reflective surfaces, as set forth in U.S. patent provisional application Ser. No. 60/620,395 filed Oct. 19, 2004, the subject matter being incorporated herein by reference. In another embodiment, the lightpipe can be replaced or combined with one or a bundle of optical fibers. Specifically, the LEDs can be positioned proximate to the entrance of the optical fiber(s) such that the color light beams enter into the optical fiber(s) and propagate in the optical fiber(s) from the entrance to the exit that is aligned to the pixels of the spatial light modulator. In an instance wherein multiple spatial light modulators are designated for modulating different color light beams, a bundle of optical fibers may be desired, but not required. The LEDs for the light beams of one color can be associated with one of the bundle of optical fibers for delivering the color beam to one of the spatial light modulators. Because of the flexibility of the optical fibers, optical arrangements and deign can be significantly simplified.

The display system is applicable to other display systems, one of which is demonstratively illustrated in FIG. 2. Referring to FIG. 2, projection system 106 comprises illumination system 116 providing light beams to illuminate spatial light modulator 110. The spatial light modulator comprises an array of pixels for modulating the incident light according to a stream of image data (such as bitplane data) that are derived from the desired images and video signals. The modulated light beams are then reflected by mirror 118 that reflects the modulated light beams to another mirror 122 through projection lens 126. The light beams reflected from mirror 122 are then projected to display target 114 so as to generate a pixel pattern.

The spatial light modulator can be the same as that in FIG. 1, and so are the spatial light modulator, projection lens and illumination system, which will not be discussed in detail herein. As an example, mirror 118 or mirror 122 or both are movable. For example, mirror 118 can be rotated in the plane of the paper along a rotation axis that points out from the paper. Such rotation can be driven accomplished by micro-actuator 120 (e.g. a piezo-actuator) connected to mirror 118. Similarly, mirror plate 122, if necessary, can be connected to micro-actuator 124 for rotating mirror 122.

By rotating mirror 118 or mirror 122 or both, the pixel patterns generated by the pixels of the spatial light modulator according to the image data can be moved spatially across the image area (the area where the desired images and videos are projected) in the display target so as to obtain the projected images and videos with a higher resolution than the real physical resolution (the number of physical pixels in the spatial light modulator) of the spatial light modulator, as set forth in provisional U.S. patent application Ser. No. 60/678,617 filed May 5, 2005, the subject matter being incorporated herein by reference in entirety.

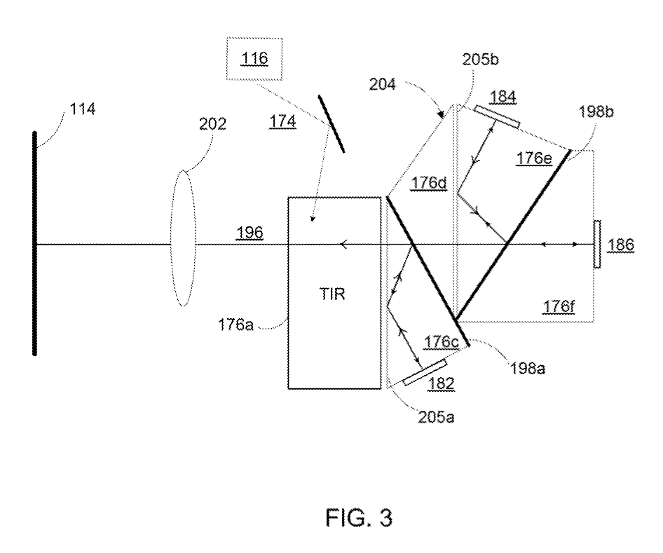

The display systems in FIG. 1 and FIG. 2 each employ one spatial light modulator. However, a display system may use multiple spatial light modulators for modulating the illumination light of different colors. One of such display systems is schematically illustrated in FIG. 3. Referring to FIG. 3, the display system uses a dichroic prism assembly 204 for splitting incident light into three primary color light beams. Dichroic prism assembly comprises TIR 176a, 176c, 176d, 176e and 176f. Totally-internally-reflection (TIR) surfaces, i.e. TIR surfaces 205a and 205b, are defined at the prism surfaces that face air gaps. The surfaces 198a and 198b of prisms 176c and 176e are coated with dichroic films, yielding dichroic surfaces. In particular, dichroic surface 198a reflects green light and transmits other light. Dichroic surface 198b reflects red light and transmits other light. The three spatial light modulators, 182, 184 and 186, each having a micromirror array device, are arranged around the prism assembly.

In operation, incident white light 174 from light source 116 enters into TIR 176a and is directed towards spatial light modulator 186, which is designated for modulating the blue light component of the incident white light. At the dichroic surface 198a, the green light component of the totally internally reflected light from TIR surface 205a is separated therefrom and reflected towards spatial light modulator 182, which is designated for modulating green light. As seen, the separated green light may experience TIR by TIR surface 205b in order to illuminate spatial light modulator 182 at a desired angle. This can be accomplished by arranging the incident angle of the separated green light onto TIR surface 205b larger than the critical TIR angle of TIR surface 205b. The rest of the light components, other than the green light, of the reflected light from the TIR surface 205a pass through dichroic surface 198a and are reflected at dichroic surface 198b. Because dichroic surface 198b is designated for reflecting red light component, the red light component of the incident light onto dichroic surface 198b is thus separated and reflected onto spatial light modulator 184, which is designated for modulating red light. Finally, the blue component of the white incident light (white light 174) reaches spatial light modulator 186 and is modulated thereby. By collaborating operations of the three spatial light modulators, red, green, and blue lights can be properly modulated. The modulated red, green, and blue lights are recollected and delivered onto display target 114 through optic elements, such as projection lens 202, if necessary.

The projection lens (108, 126, and 202) in the projection system as discussed above with reference to FIG. 1, FIG. 2, and FIG. 3 can be any suitable projection lenses. Specifically, the projection lenses may have a back-focal length of 186 mm or less, 40 mm or less, 33 mm or less, 27 mm or less, 24 mm or less, 20.7 mm or less, 18 mm or less, and 17 mm or less. The f-number of the projection lens can be from f/1.8 to f/4, more preferably around f/2.4 with f being the back-focal length, as set forth in co-pending US patent application “MICROMIRROR-BASED PROJECTION SYSTEMS WITH OPTICS HAVING SHORT FOCAL LENGTHS”, attorney docket number P269-US, the subject matter being incorporated herein by reference.

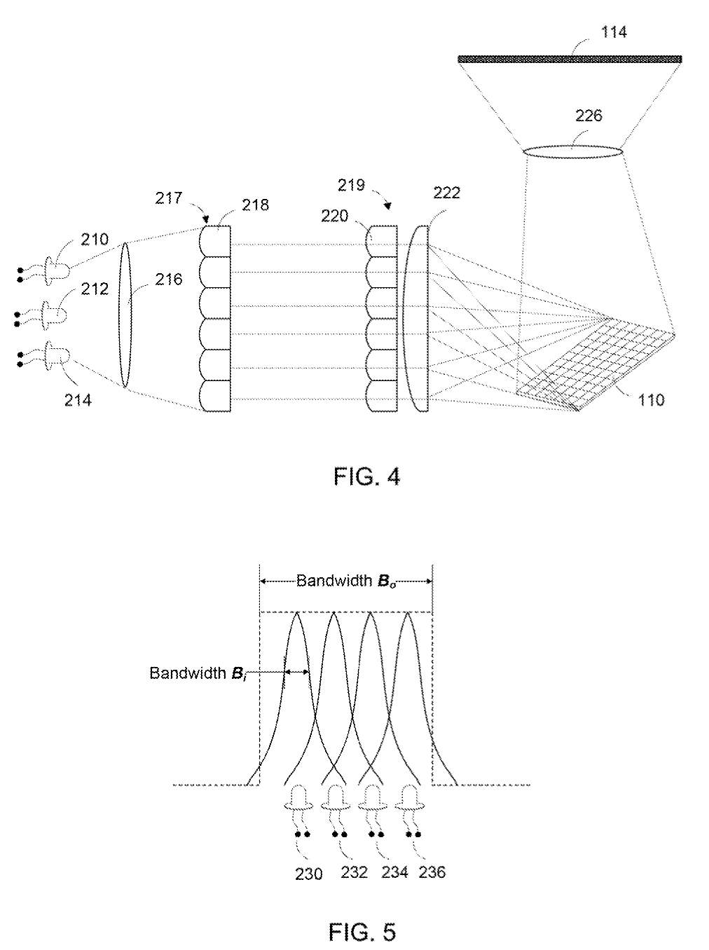

Referring to FIG. 4, another exemplary display system using LEDs as light source is demonstratively illustrated therein. In this example, the projection system comprises a LED array (e.g. LEDs 210, 212, and 214) for providing illumination light beam for the system. For demonstration purposes only, three LEDs are illustrated in the figure. In practice, the LED group may have any suitable number of LEDs, including a single LED. The LEDs can be of the same color (e.g. white color) or different colors (e.g. red, green, and blue). The light beams from the LED array are projected onto front fly-eye lens 217 through collimation lens 216. Fly-eye lens 217 comprises multiple unit lenses such as unit lens 218. The unit lenses on fly-eye lens 217 can be cubical lens or any other suitable lenses, and the total number of the unit lenses in the fly-eye lens 217 can be any desired numbers. At fly-eye lens 218, the light beam from each of the LEDs 210, 212, and 214 is split into a number of sub-light beams with the total number being equal to the total number of unit lenses of fly-eye lens 218. After collimate lens 216 and fly-eye lens 217, each LEDs 210, 214, and 216 is imaged onto each unit lens (e.g. unit lens 220) of rear fly-eye lens 219. Rear fly-eye lens 219 comprises a plurality of unit lenses each of which corresponds to one of the unit lenses of the front fly-eye lens 217, such that each of the LEDs forms an image at each unit lens of the rear fly-eye lens 219. Projection lens 222 projects the light beams from each unit lens of fly-eye lens 219 onto spatial light modulator 110. With the above optical configuration, the light beams from the LEDs (e.g. LEDs 210, 212, and 214) can be uniformly projected onto the micromirror devices of the spatial light modulator.

In the display system, a single LED can be used, in which instance, the LED preferably provides white color. Alternatively, an array of LEDs capable of emitting the same (e.g. white) or different colors (e.g. red, green, and blue) can be employed. Especially when multiple LEDs are employed for producing different colors, each color can be produced by one or more LEDs. In practical operation, it may be desired that different colors have approximately the same or specific characteristic spectrum widths. It may also be desired that different colors have the same illumination intensity. These requirements can be satisfied by juxtaposing certain number of LEDs with slightly different spectrums, as demonstratively shown in FIG. 5.

Referring to FIG. 5, it is assumed that the desired spectrum bandwidth of a specific color (e.g. red) is Bₒ (e.g. a value from 10 nm to 80 nm, or from 60 nm to 70 nm), and the characteristic spectrum bandwidth of each LED (e.g. LEDs 230, 232, 234, and 236) is Bᵢ (e.g. a value from 10 nm to 35 nm). By properly selecting the number of LEDs with suitable spectrum differences, the desired spectrum can be obtained. As a way of example, assuming that the red color with the wavelength of 660 nm and spectrum bandwidth of 60 nm is desired, LEDs 230, 232, 234, and 236 can be selected and juxtaposed as shown in the figure. LED 230, 232, 234, and 236 may have characteristic spectrum of 660 nm, 665 nm, 670 nm, and 675 nm, and the characteristic spectrum width of each LED is approximately 10 nm. As a result, the effective spectrum width of the juxtaposed LEDs can approximately be the desired red color with the desired spectrum width.

Different LEDs emitting different colors may exhibit different intensities, in which instance, the color balance is desired so as to generate different colors of the same intensity. An approach is to adjust the ratio of the total number of LEDs for the different colors to be balanced according to the ratio of the intensities of the different colors, such that the effective output intensities of different colors are approximately the same.

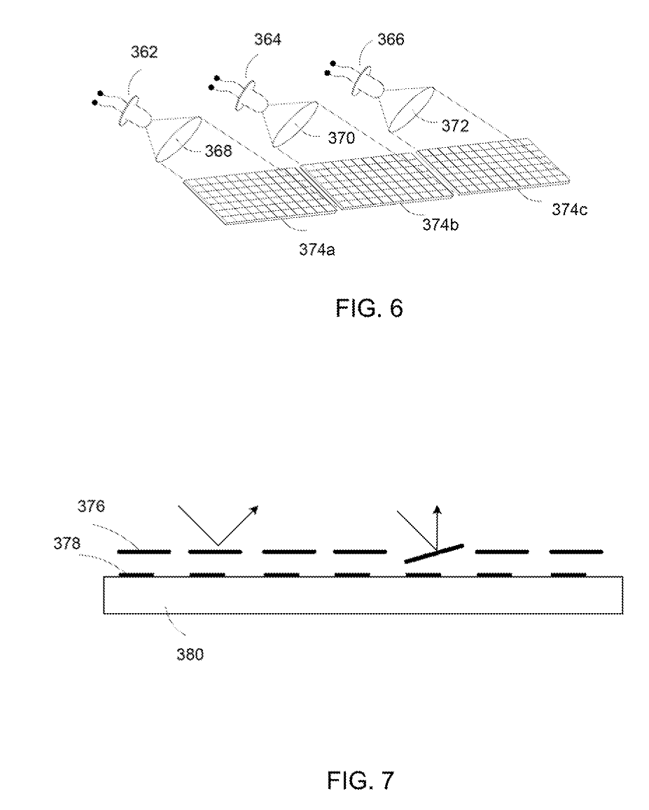

In the display system wherein LEDs are provided for illuminating a single spatial light modulator with different colors, the different colors can be sequentially directed to the spatial light modulator. For this purpose, the LEDs for different colors can be sequentially turned on, and the LEDs for the same color are turned on concurrently. In another system, multiple spatial light modulators can be used as set froth in US patent application “Multiple Spatial Light Modulators in a Package” to Huibers, attorney docket number P266-pro, filed Aug. 30, 2005, the subject matter being incorporated herein by reference in entirety. A group of LEDs can be employed in such a display system for producing different colors that sequentially or concurrently illuminate the multiple spatial light modulators, as demonstrated in FIG. 6.

Referring to FIG. 6, LEDs 362, 364, and 366, emitting different colors, such as red, green, and blue, or cyan, yellow, and magenta, are used for illuminating spatial light modulators 374a, 374b, and 374c through lenses 368, 370, and 372, respectively. The illumination can be sequential or concurrent. For sequentially illuminating the multiple spatial light modulators, the LEDs emitting the same color are turned on at the same time, while the groups of LEDs emitting different colors are turned on sequentially. For concurrently illuminating the multiple spatial light modulators with different colors, different groups of LEDs emitting different colors can be turned on concurrently. The multiple spatial light modulators respectively modulate the different colors. The modulated different colors are then integrated so as to form the desired color images or videos. In addition to the display system as discussed above, other projection systems are also applicable, such as those set forth in U.S. patent application Ser. No. 60/678,617 filed May 5, 2005, the subject matter being incorporated herein by reference in its entirety.

The spatial light modulators of the display systems in FIGS. 1 to 6 each comprise an array of micromirror devices each of which has a reflective and deflectable mirror plate. A cross-sectional view of an exemplary spatial light modulator having an array of reflective and deflectable mirror plates is demonstratively illustrated in FIG. 7. Referring to FIG. 7, the spatial light modulator comprises an array of reflective and deflectable mirror plates, such as mirror plate 376. For simplicity purposes, only 7 mirror plates are illustrated therein. However, the spatial light modulator may comprise any desired number of mirror plates, which is referred to as the natural resolution of the spatial light modulator, is preferably 640×480 (VGA) or higher, such as 800×600 (SVGA) or higher, 1024×768 (XGA) or higher, 1280×1024 (SXGA) or higher, 1280×720 or higher, 1400×1050 or higher, 1600×1200 (UXGA) or higher, and 1920×1080 or higher. The diameter of the micromirror array is preferably from 0.55 inch to 0.8 inch, more preferably from 0.65 to 0.85 inch, and more preferably around 0.7 inch. The total number of mirror devices in the spatial light modulator. The micromirror devices each have a characteristic dimension in the order of microns, such as 100 micros or less, 50 microns or less, and 15 microns or less. The micromirror devices are arranged in arrays preferably with a pitch of 10.16 microns or less, such as from 4.38 to 10.16 microns. The gap between the adjacent micromirror devices is preferably 1.5 microns or less, such as 1 micron or less, 0.5 micron or less, more preferably from 0.1 to 0.5 micron, as set forth in U.S. patent application Ser. No. 10/627,302 filed Jul. 24, 2003, the subject matter being incorporated herein by reference in entirety.

The mirror plates are operated in an ON and OFF state. The ON state corresponds to a state wherein the mirror plate is rotated to an ON state angle of 10° degrees or more, more preferably 12° degrees or more, 14° degrees or more, and 16.5° degrees or more, 17.5° degrees or more, and 200 degrees or more relative to a substrate on which the mirror plates are formed. The OFF state corresponds to a state wherein the mirror plate is parallel to the substrate on which the mirror plates are formed, or at an OFF angle that is from −0.5° to −10° degrees, preferably from −1° to −9°, or from −1° to −4° degrees relative to the substrate on which the mirror plates are formed.

For deflecting the mirror plates to the ON state, each mirror plate is associated with one or more addressing electrodes, such as addressing electrode 378 on semiconductor substrate 380 for being electrostatically deflected. Specifically, when a mirror plate is desired to be at the ON state, an electrostatic field is established between the mirror plate and the associated addressing electrode. The electrostatic field derives an electrostatic force, which in turn, yields exerts and electrostatic torque to the mirror plate. With the electrostatic torque, the mirror plate moves to the ON state.

In the above example, each mirror plate is associated with one addressing electrode for deflecting the mirror plate according to the image data. In another embodiment, each mirror plat can be associated with multiple addressing electrodes, which will not be detailed herein. In addition to the addressing electrodes, another electrode can be provided for deflecting the mirror plate in the direction opposite to that resulted from the addressing electrode.

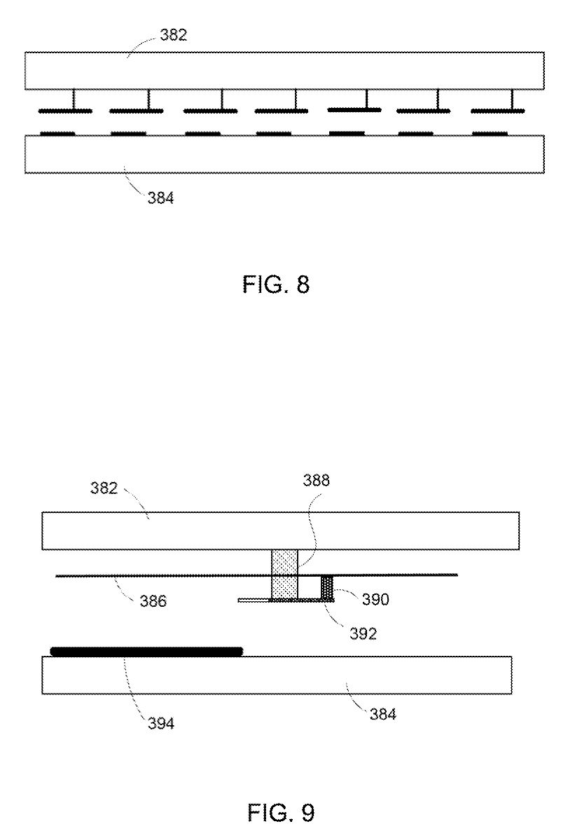

Referring to FIG. 8, an exemplary spatial light modulator is illustrated therein. In this specific example, the reflective and deflectable mirror plates are formed on light transmissive substrate 382, such as glass, quartz, and sapphire. The addressing electrodes are formed on semiconductor substrate 384. The two substrates can be bonded together with a spacer so as to maintain a uniform and constant vertical distance therebetween.

The spatial light modulator may have other features, such as a light transmissive electrode formed on the light transmissive substrate, as set forth in U.S. patent application Ser. No. 11/102,531 filed Apr. 8, 2005, the subject matter being incorporated herein by reference in its entirety.

Alternative to forming the mirror plates on a separate substrate than the semiconductor substrate on which the addressing electrodes are formed, the mirror plates and addressing electrodes can be formed on the same substrate, which preferably the semiconductor substrate, which is not shown in the figure.

In another embodiment, the mirror plates can be derived from a single crystal, such as single crystal silicon, as set forth in U.S. patent application Ser. No. 11/056,732, Ser. No. 11/056,727, and Ser. No. 11/056,752 all filed Feb. 11, 2005, the subject matter of each being incorporated herein by reference in entirety.

The micromirrors as shown in FIG. 8 have a variety of different configurations, one of which is demonstratively illustrated in a cross-sectional view in FIG. 9. Referring to FIG. 9, the micromirror device comprises reflective deflectable mirror plate 386 that is attached to deformable hinge 392 via hinge contact 390. The deformable hinge, such as a torsion hinge is held by a hinge support that is affixed to post 388 on light transmissive substrate 382. Addressing electrode 394 is disposed on semiconductor substrate 384, and is placed proximate to the mirror plate for electrostatically deflecting the mirror plate. Other alternative features can also be provided. For example, a stopper can be provided for limiting the rotation of the mirror plate when the mirror plate is at the desired angles, such as the ON state angle. For enhancing the transmission of the incident light through the light transmissive substrate 382, an anti-reflection film can be coated on the lower surface of substrate 382. Alternative the anti-reflection film, a light transmissive electrode can be formed on the lower surface of substrate 382 for electrostatically deflecting the mirror plate towards substrate 382. An example of such electrode can be a thin film of indium-tin-oxide. The light transmissive electrode can also be a multi-layered structure. For example, it may comprise an electrically conductive layer and electrically non-conductive layer with the electrically conductive layer being sandwiched between substrate 382 and the electrically non-conductive layer. This configuration prevents potential electrical short between the mirror plate and the electrode. The electrically non-conductive layer can be SiOₓ, TiOₓ, SiNₓ, and NbOₓ, as set forth in U.S. patent application Ser. No. 11/102,531 filed Apr. 8, 2005, the subject matter being incorporated herein by reference. In other examples, multiple addressing electrodes can be provided for the micromirror device, as set forth in U.S. patent application Ser. No. 10/437,776 filed May 13, 2003, and Ser. No. 10/947,005 filed Sep. 21, 2004, the subject matter of each being incorporated herein by reference in entirety. Other optical films, such as a light transmissive and electrically insulating layer can be utilized in combination with the light transmissive electrode on the lower surface of substrate 382 for preventing possible electrical short between the mirror plate and light transmissive electrode.

In the example shown in FIG. 9, the mirror plate is associated with one single addressing electrode on substrate 384. Alternatively, another addressing electrode can be formed on substrate 178, but on the opposite side of the deformable hinge.

The micromirror device as show in FIG. 9 is only one example of many applicable examples. For example, in the example as shown in FIG. 9 the mirror plate is attached to the deformable hinge such that the mirror plate rotates asymmetrically. That is the maximum rotation angle (e.g. the ON state angle) achievable by the mirror plate rotating in one direction (the direction towards the ON state) is larger than that (e.g. the OFF stat angle) in the opposite rotation direction (e.g. the direction towards the OFF state). This is accomplished by attaching the mirror plate to the deformable hinge at a location that is not at the center of the mirror plate such that the rotation axis of the mirror plate is offset from a diagonal of the mirror plate. However, the rotation axis may or may not be parallel to the diagonal. Of course, the mirror plate can be attached to the deformable hinge such that the mirror plate rotates symmetrically. That is the maximum angle achievable by rotating the mirror plate is substantially the same as that in the opposite rotation direction.

The mirror plate of the micromirror shown in FIG. 9 can be attached to the deformable hinge such that the mirror plate and deformable hinge are in the same plane. In an alternative example, the deformable hinge can be located in a separate plane as the mirror plate when viewed from the top of the mirror plate at a non-deflected state, which will not be discussed in detail herein.

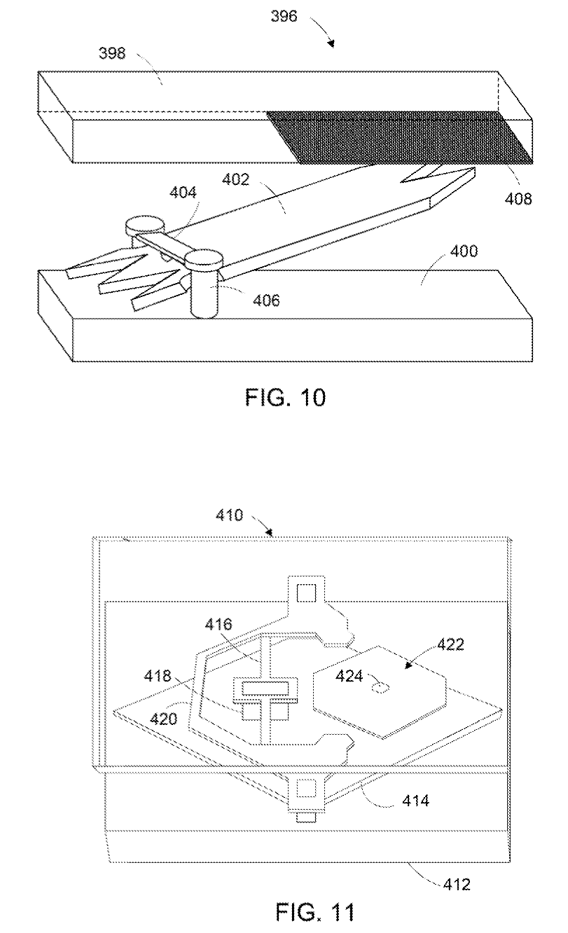

In the following, selected exemplary micromirror devices having the cross-sectional view of FIG. 9 will be discussed with reference to FIG. 10 and FIG. 11. It will be immediately understood by those skilled in the art that the following discussion is for demonstration purposes only and is not intended to be limiting. Instead, any variations without departing from the spirit of the invention are also applicable.

Referring to FIG. 10, a perspective view of an exemplary micromirror is illustrated therein. Micromirror device 396 comprises substrate 400 that is a light transmissive substrate such as glass, quartz, and sapphire and semiconductor substrate 398, such as silicon substrate. Deflectable and reflective mirror plate 402 is spaced apart and attached to deformable hinge 404 via a hinge contact. The deformable hinge is affixed to and held by posts 406. The semiconductor substrate has addressing electrode 408 for deflecting the mirror plate. A light blocking pad can be alternatively formed between the surface of post 406 and substrate 400 for reducing unexpected light scattering from the exposed surface of the posts.

The deflectable and reflective mirror plate can be a multilayered structure. For example, the mirror plate may comprise an electrical conducting layer, a reflective layer that is capable of reflecting 85% or more, or 90% or more, or 85% or more, or 99% or more of the incident light (e.g. incident visible light), a mechanical enhancing layer that enhances the mechanical properties of the mirror plate. An exemplary mirror plate can be a multilayered structure comprising a SiO₂ layer, an aluminum layer, a titanium layer, and a titanium nitride layer. When aluminum is used for the mirror plate; and amorphous silicon is used as the sacrificial material, diffusion between the aluminum layer and the sacrificial material may occur. This can be avoided by depositing a barrier layer therebetween.

Another exemplary micromirror device having a cross-sectional view of FIG. 9 is illustrated in its perspective view in FIG. 11. Referring to FIG. 11, deflectable reflective mirror plate 414 with a substantially square shape is formed on light transmissive substrate 412, and is attached to deformable hinge 416 via hinge contact 418. The deformable hinge is held by hinge support 420, and the hinge support is affixed and held by posts on the light transmissive substrate. For electrostatically deflecting the mirror plate, an addressing electrode (not shown in the figure for simplicity purposes) is fabricated in the semiconductor substrate 410. For improving the electrical coupling of the deflectable mirror plate to the electrostatic field, extending metallic plate 422 can be formed on the mirror plate and contacted to the mirror plate via post 424. A light blocking pad can be alternatively disposed between the surface of the post and substrate 412 so as to reduce unexpected light scattering from the post. The light blocking pad can also be deployed in a way so as to block light scattered from other portions of the micromirror, such as the tips (or the corners) of the mirror plate of the micromirror, and the exterior surfaces (e.g. the walls) of the posts.

The mirror plate is preferably attached to the deformable hinge asymmetrically such that the mirror plate can be rotated asymmetrically for achieving high contrast ratio. Similar to that shown in FIG. 10, the deformable hinge is preferably formed beneath the deflectable mirror plate in the direction of the incident light so as to avoid unexpected light scattering by the deformable hinge. For reducing unexpected light scattering of the mirror plate edge, the illumination light is preferably incident onto the mirror plate along a corner of the mirror plate.

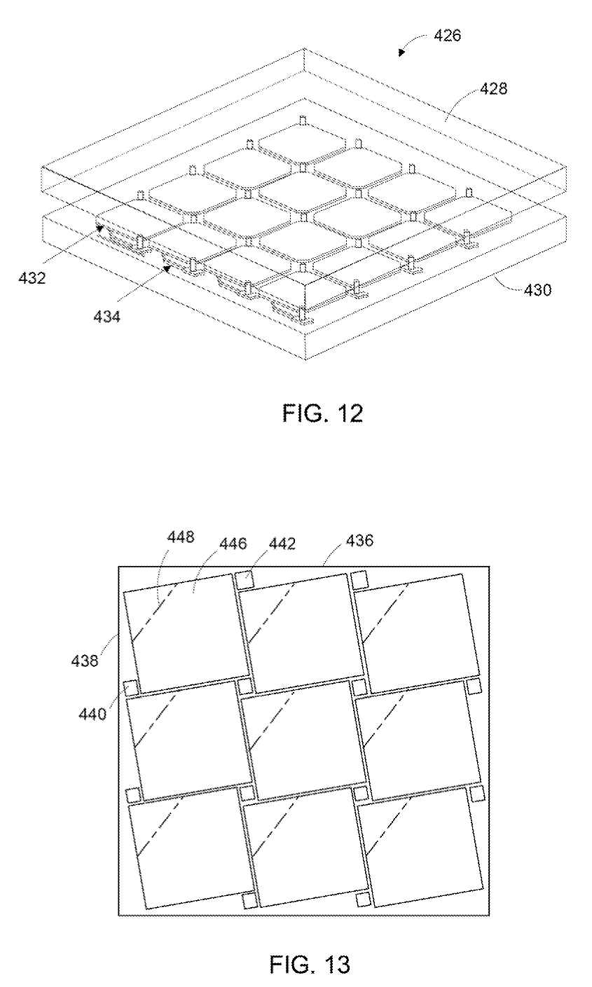

Referring to FIG. 12, an exemplary spatial light modulator having an array of micromirrors of FIG. 11 is illustrated therein. For simplicity purposes, only 4×4 micromirrors are presented. In general, the micromirror array of a spatial light modulator consists of thousands or millions of micromirrors, the total number of which determines the resolution of the displayed images. For example, the micromirror array of the spatial light modulator may have 800×600 (SVGA) or higher, 1024×768 (XGA) or higher, 1280×1024 (SXGA) or higher, 1280×720 or higher, 1400×1050 or higher, 1600×1200 (UXGA) or higher, and 1920×1080 or higher, micromirror devices. In other applications, the micromirror array may have less number of micromirrors.

In this example, the array of deflectable reflective mirror plates 432 is disposed between light transmissive substrate 428 and semiconductor substrate 430 having formed thereon an array of addressing electrodes 434 each of which is associated with a mirror plate for electrostatically deflecting the mirror plate. The posts of the micromirrors can be covered by light blocking pads for reducing expected light scattering from the surfaces of the posts.

In operation, the illumination light passes through the light transmissive substrate and illuminates the reflective surfaces of the mirror plates, from which the illumination light is modulated. The illumination light incident onto the areas corresponding to the surfaces of the posts are blocked (e.g. reflected or absorbed depending upon the materials of the light blocking pads) by the light blocking pads. The reflected illumination light from the mirror plates at the ON state is collected by the projection lens so as to generate a “bright” pixel in the display target. The reflected illumination from the mirror plates at the OFF state travels away from the projection lens, resulting in the corresponding pixels imagined at the display target to be “dark.”

The micromirrors in the micromirror array of the spatial light modulator can be arranged in alternative ways, another one of which is illustrated in FIG. 13. Referring to FIG. 13, each micromirror is rotated around its geometric center an angle less than 45° degrees. The posts (e.g. 440 and 442) of each micromirror (e.g. mirror 446) are then aligned to the opposite edges of the mirror plate. No edges of the mirror plate are parallel to an edge (e.g. edges 436 or 438) of the micromirror array. The rotation axis (e.g. axis 448) of each mirror plate is parallel to but offset from a diagonal of the mirror plate when viewed from the top of the mirror plate at a non-deflected state.

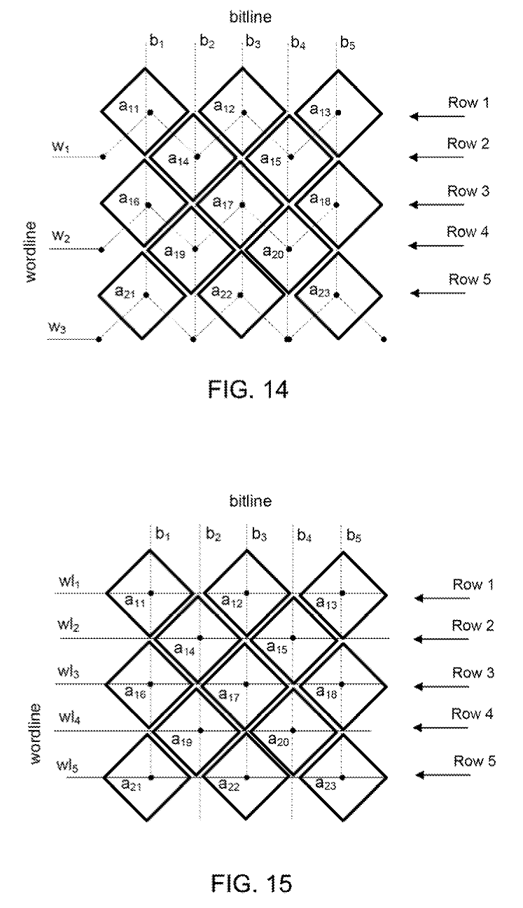

FIG. 14 illustrates the top view of another micromirror array having an array of micromirrors of FIG. 9. In this example, each micromirror is rotated 45° degrees around its geometric center. For addressing the micromirrors, the bitlines and wordlines are deployed in a way such that each column of the array is connected to a bitline but each wordline alternatively connects micromirrors of adjacent rows. For example, bitlines b₁, b₂, b₃, b₄, and b₅ respectively connect micromirrors groups of (a₁₁, a₁₆, and a₂₁), (a₁₄ and a₁₉), (a₁₂, a₁₇, and a₂₂), (a₁₅ and a₂₀), and (a₁₃, a₁₈, and a₂₃). Wordlines w₁, w₂, and w₃ respectively connect micromirror groups (a₁₁, a₁₄, a₁₂, a₁₅, and a₁₃), (a₁₆, a₁₉, a₁₇, a₂₀, and a₁₈), and (a₂₁, a₂₂, and a₂₃). With this configuration, the total number of wordlines is less the total number of bitlines.

For the same micromirror array, the bitlines and wordlines can be deployed in other ways, such as that shown in FIG. 15. Referring to FIG. 15, each row of micromirrors is provided with one wordline and one bitline. Specifically, bitlines b₁, b₂, b₃, b₄ and b₅ respectively connect column 1 (comprising micromirrors a₁₁, a₁₆, and a₂₁), column 2 (comprising micromirrors a₁₄ and a₁₉), column 3 (comprising micromirrors a₁₂, a₁₇, and a₂₂), column 4 (comprising micromirrors a₁₅ and a₂₀), and column 5 (comprising micromirrors a₁₃, a₁₈, and a₂₃). Wordlines WL₁, WL₂, WL₃, WL₄, and WL₅ respectively connect row 1 (comprising micromirrors a₁₁, a₁₂, and a₁₃), row 2 (comprising micromirrors a₁₄ and a₁₅), row 3 (comprising micromirrors a₁₆, a₁₇, and a₁₈), row 4 (comprising micromirrors a₁₉ and a₂₀) and row 5 (comprising micromirrors a₂₁, a₂₂, and a₂₃).

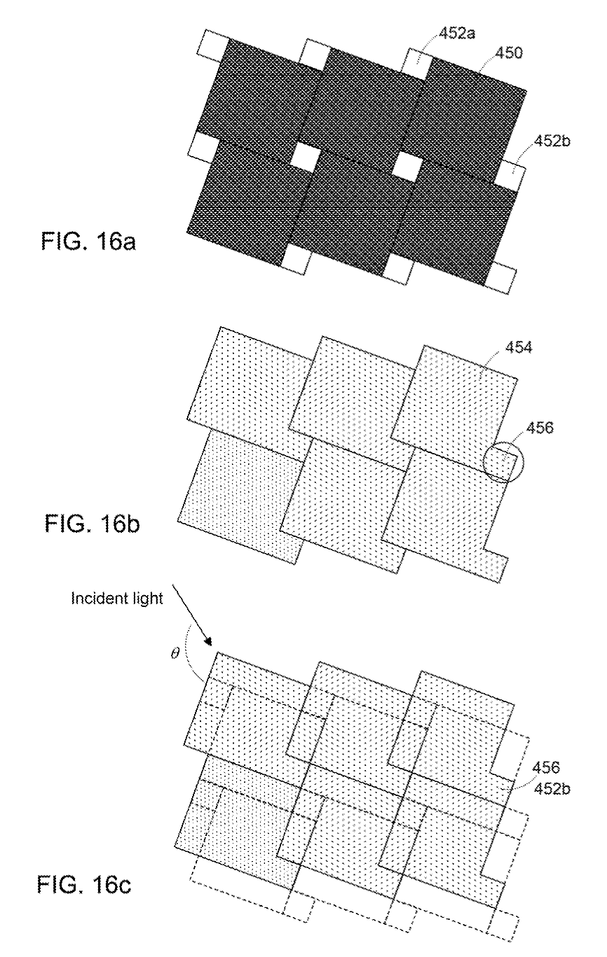

In another example, the mirror plates of the micromirrors in the array can form a plurality of pockets, in which posts can be formed, wherein the pockets are covered by the extended areas of the addressing electrodes when viewed from the top of the micromirror array device, as shown in FIGS. 16a to 16c.

Referring to FIG. 16a, a portion of an array of mirror plates of the micromirrors is illustrated therein. The mirror plates in the array form a plurality of pockets in between. For example, pockets 452a and 452b are formed in which posts for supporting and holding mirror plate 450 can be formed. For individually addressing and deflecting the mirror plates in FIG. 16a, an array of addressing electrodes is provided, a portion of which is illustrated in FIG. 16b.

Referring to FIG. 16b, each addressing electrode has an extended portion, such as extended portion 456 of addressing electrode 454. Without the extended portion, the addressing electrode can be generally square, but having an area equal to or smaller than the mirror plate.

FIG. 16c illustrates a top view of a micromirror array device after the addressing electrodes in FIG. 16b and the mirror plates in FIG. 16a being assembled together. It can be seen in the figure that each addressing electrode is displaced a particular distance along a diagonal of the mirror plate associated with the addressing electrode. As a result, the pockets presented between the mirror plates are covered by the addressing electrode, specifically by the extended portions of the addressing electrodes. In this way, light scattering otherwise occurred in the substrate having the addressing electrodes can be removed. The quality, such as the contrast ratio of the displayed images can be improved.

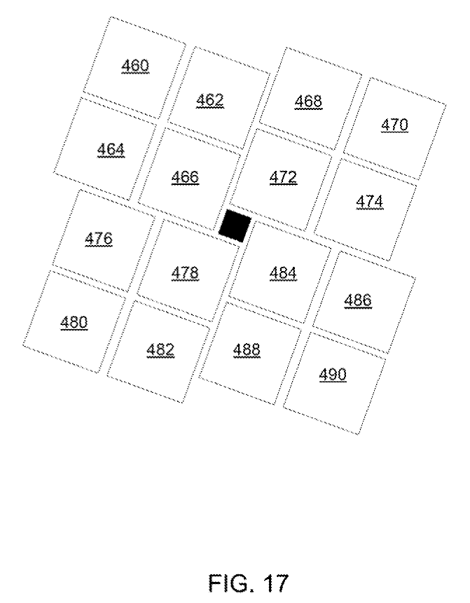

In yet another example, not all the micromirror devices of a spatial light modulator have posts (e.g. at that set forth in U.S. patent application Ser. No. 10/969,251 and Ser. No. 10/969,503 both filed Oct. 19, 2004, the subject matter of each being incorporated herein by reference in entirety. An example of such micromirror array device is illustrated in a top view in FIG. 17. For simplicity purposes, only sixteen micromirror devices of the micromirror array device are illustrated. In this specific example, every four adjacent micromirrors are formed into a micromirror group, such as the group comprising micromirrors 460, 462, 464, and 466, the group comprising 468, 470, 472, and 474, the group comprising micromirrors 476, 478, 480, and 482, and the group comprising micromirrors 484, 486, 488 and 490. Adjacent groups (e.g. the above four micromirror groups) share a post that is represented by the black square for supporting the mirror plates of the micromirrors in the four micromirror groups. The exposed surface of the post can be covered by a light blocking film. In general, the posts of a micromirror array device, wherein not all micromirrors are provided with a post, can all be coated with light blocking pads. Alternatively, only a number of (but not all) the posts are coated with light blocking pads.

In the above discussed exemplary micromirror arrays with reference to FIGS. 3 to 17, each mirror plate is capable of being rotated to the ON state angle that is 10° degrees or more, more preferably 12° degrees or more, 14° degrees or more, and 16.5° degrees or more, 17.5° degrees or more, and 20° degrees or more relative to a substrate on which the mirror plates are formed. The OFF state of the mirror plates can be parallel to the substrates on which the mirror plates are formed, or from −0.5° to −10° degrees, preferably from −1° to −9°, or from −1° to −4° degrees relative to the substrate on which the mirror plates are formed. The ON state angle enables the incident light to be obliquely incident onto the reflective mirror plates at large acute incident angles. As an example, the incident light has an acute angle Φ relative to the reflective surfaces of the mirror plates at the natural resting state. The projection of the incident light on the reflective surfaces has an acute angle of β to an edge of the micromirror array, and an obtuse angle of ω to an edge of the mirror plate. Angle φ is equal to (90°−2×θ_{ON}) with θ_{ON} being the ON state angle. Depending upon θ_{ON}, angle φ can be 70° degrees or less, such as 66° degrees or less, 62° degrees or less, 57° degrees or less, 55° degrees or less, 50° degrees or less, more preferably around 33° degrees. Angle β can be of any suitable values, such as from 0° to 90° degrees, and from 20° to 65° degrees, from 50° to 65° degrees, and more preferably around 32.8 degrees. Obtuse angle ω can be any suitable values, depending upon the geometric shape of the mirror plate. In the instance wherein the mirror plate is substantially square, the obtuse angle ω can be from 90° degrees to 135° degrees, such as from 105° degrees to 135° degrees, from 119° degrees to 135° degrees, and from 113° degrees to 135 degrees, and from 122.8° degrees to 135° degrees.

It will be appreciated by those of ordinary skill in the art that a new and useful digital display system capable of producing color images without a color filter has been described herein. In view of the many possible embodiments, however, it should be recognized that the embodiments described herein with respect to the drawing figures are meant to be illustrative only and should not be taken as limiting the scope of what is claimed. Those of skill in the art will recognize that the illustrated embodiments can be modified in arrangement and detail. Therefore, the devices and methods as described herein contemplate all such embodiments as may come within the scope of the following claims and equivalents thereof.

We claim:

1. A projection system capable of producing a color image, comprising:
an illumination system comprising an array of light sources capable of producing a set of color light beams;
a spatial light modulator comprising an array of micromirror devices for modulating the incident light;
a projection lens for projecting the modulated light onto a screen;
wherein a color wheel with a multiplicity of color segments capable of producing the set of color light beams is absent from the projection system; and
wherein the illumination system is optically coupled to the spatial light modulator without a condensing lens.

2. The system of claim 1, where the illumination system is optically coupled to the spatial light modulator with a lightpipe; and wherein a condensing lens is absent between the lightpipe and spatial light modulator.

3. The system of claim 1, further comprising another array of micromirror devices for modulating the light.

4. The system of claim 1, wherein the illumination system comprises a LED.

5. The system of claim 4, wherein the LED is a member of an array of LEDs capable of providing different colors.

6. The system of claim 5, wherein the LEDs are capable of emitting red, green, and blue colors.

7. The system of claim 5, wherein the LEDs are capable of providing white color.

8. The system of claim 7, further comprising a beam splitter that is static during a projection operation, wherein the beam splitter comprises a diachronic coating for separating different colors from an incident light.

9. The system of claim 5, wherein the group of LEDs comprises a first sub-group of LEDs for emitting the first color, and a second group of LEDs for emitting the second color; and wherein the numbers of LEDs in the first and second sub-groups are different.

10. The system of claim 1, wherein the group of LEDs comprises a sub-group of LEDs for emitting the same color; and wherein the LEDs in said sub-group have different characteristic spectrums.

11. The system of claim 1, wherein the illumination system comprises a lightpipe for directing the light to the array of micromirror devices.

12. The system of claim 1, wherein a lightpipe is absent from the system.

13. The system of claim 1, wherein the array of micromirror devices have a characteristic dimension of 0.7 inches or less.

14. The system of claim 1, wherein the array of micromirror devices have a characteristic dimension of 0.45 inches or less.

15. The system of claim 1, wherein the micromirror devices in the array have a center-to-center distance between the adjacent micromirror devices of 15 microns or less.

16. The system of claim 1, wherein the micromirror devices in the array have a center-to-center distance between the adjacent micromirror devices of 10.16 microns or less.

17. The system of claim 1, wherein the micromirror devices in the array have a minimum gap distance between the adjacent micromirror devices of 1.5 microns or less.

18. The system of claim 1, wherein the micromirror devices in the array have a minimum gap distance between the adjacent micromirror devices of from 0.1 to 0.5 microns or less.

19. The system of claim 1, wherein the projection lens has a back-focal length of 20.7 mm or less.

20. The system of claim 1, wherein the projection lens has a back-focal length of 18 mm or less.

21. The system of claim 1, wherein the projection lens has a back-focal length of 17 mm or less.

22. The system of claim 1, wherein the projection lens has a f-number of f/1.8 or less.

23. The system of claim 1, wherein the projection lens has a f-number of f/2.4 or less.

24. The system of claim 1, wherein the projection lens has a f-number of f/2.6 or less.

25. The system of claim 1, wherein the array has 640×480 or more number of micromirror devices.

26. The system of claim 1, wherein the array has 1024×768 or more number of micromirror devices.

27. The system of claim 1, wherein the array has 1280×1024 or more number of micromirror devices.

28. The system of claim 1, further comprising:
means for projecting a light beam reflected from one of the micromirror devices in the array to a plurality of different locations on the screen.

29. The system of claim 28, wherein the means comprises:
a movable folding mirror.

30. The system of claim 1, further comprising:
a relay lens.

31. The system of claim 1, wherein the light beam from a light source of the illumination system consecutively passes a lightpipe, a field lens, and a relay lens to the micromirror device array.

32. The system of claim 1, wherein the light beam from a light source of the illumination system consecutively passes an optical fiber and a relay lens to the micromirror device array.

33. The system of claim 1, wherein the light beam from a light source of the illumination system consecutively passes a relay lens to the micromirror device array.
